(19) United States
(12) Patent Application Publication
(10) Pub. No.: US 2002/0087336 A1
(43) Pub. Date: Jul. 4, 2002

(54) Business model for virtual vertically integrated network-based business having information, product, and financial flows

(76) Inventors: Don Eden Hale, Ft. Collins, CO (US); Monte Richard Campbell, Fort Collins, CO (US); Anne Margret Peterson, Fort Collins, CO (US); Todd Coleman Metcalf, Fort Collins, CO (US); Angelo Mauricio Forero Gomez, Fort Collins, CO (US)

Correspondence Address: AGILENT TECHNOLOGIES, Legal Department, 51U-PD, Intellectual Property Administration, P.O. Box 58043, Santa Clara, CA, 95052-8043, US

(21) Appl. No.: 09/750,833

(22) Filed: Dec. 29, 2000

(51) Int. Cl. G06F 17/60

(52) U.S. Cl. 705/1

(57) ABSTRACT

A business method and model for integrating outsourced functions in a virtual enterprise system for the manufacture, warehousing, and distribution of a product. The business model includes virtual alliances and multiple virtual flows to enable electronic communication between the virtual alliances for use in the manufacture and distribution of the product. The virtual flows include material and product flows to coordinate raw materials for the product, information flows to coordinate shipping and warehousing, and financial flows to process financial transactions during the manufacture and distribution of the product. A contracting business provides for coordination among the virtual alliances and establishes, via the virtual flows, strategic control over the manufacture and distribution of the product by the virtual alliances.

### FIELD OF THE INVENTION

The present invention relates to a business model for a virtually integrated business on the world wide web, or other network, and having information, material/product, and financial flows for coordinating business activities over the network.

### BACKGROUND OF THE INVENTION

Recently, a shift has occurred to outsource the main functions of a vertically integrated company. First, outsourcing occurred of the basic components that required little skill such as sheet metal and plastics. Then, more of the complex technical work was outsourced, such as the making and assembly of printed circuit boards in the electronics industry. Eventually, companies began to see that they could leverage outsourcing for the entire product, from sourcing the raw materials to the end product itself. However, as this outsourcing of the main functions took place, little attention was paid to how all of these functions would be connected and integrated together. Accordingly, a need exists for a business model to integrate outsourced functions for manufacturing and distributing a product.

### SUMMARY OF THE INVENTION

A fully integrated virtual enterprise system connects various outsourced functions for a virtual business method and model. The business model, and the method of using it, includes a plurality of virtual alliances for the manufacture and distribution of the product. A plurality of virtual flows enable electronic communication between the plurality of virtual alliances for use in the manufacture and distribution of the product. A contracting business provides for coordination among the virtual alliances and establishes, via the virtual flows, control over the manufacture and distribution of the product by the plurality of virtual alliances.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of entities integrated within a virtual business;

FIG. 2 is a diagram of a material and product flows within the virtual business;

FIG. 3 is a diagram of information flows within the virtual business;

FIG. 4 is a diagram of financial flows within the integrated business;

FIG. 5 is a diagram illustrating the integration of the product, information, and financial flows within the virtual business;

FIG. 6 is a diagram illustrating interaction between a contracting business strategic role and the information flows within the virtual business;

FIG. 7 is a diagram illustrating an example of a virtually integrated business using the product, information, and financial flows for finished goods only; and

FIG. 8 is a diagram illustrating additional detail for the information flows in the example of a global application in FIG. 7.

### DETAILED DESCRIPTION

### Overview

Three main virtual flows connect the various functions of a vertically integrated company together: material/product, information, and financial. All of the functions, for example, of a vertically integrated company can be outsourced including the connectivity functions, allowing businesses to focus on their core competencies and allowing other companies to purchase materials and services from sources that are more efficient than they are. Thus, the connectivity portion to be outsourced links all of the various global suppliers of manufacturing and delivery into one virtually integrated company.

A fully integrated virtual enterprise system, consistent with the present invention, allows for these various global raw material sources and manufacturing entities to be combined into one as if they were one globally integrated company, with the main company entity, or contracting business, controlling and monitoring strategic main flows. The contracting business can have a fair measure of control and yet still take advantage of core competencies of other global operations. Core competencies of the contracting business, such as branding, development, product generation and development, alliance selection and qualification, and marketing are its main focus. Suppliers of operations and products can be selected from any source in the world, connected together virtually with the business model system, and function as a vertically integrated company.

The virtual connections can occur, for example, over the Internet and world wide web using standard Internet communications protocols for connecting the various entities. Users can interact with the virtual business using, for example, conventional web browsers or other software platforms on computers or any processor-based machine. The interaction can occur over any wireline or wireless network using conventional network communication techniques.

In a system model for the virtual business, all three flows would be outsourced to one single sub-contractor of the material/product movement, information, and financials. The sub-contractor links these together with its own assets and resources, or links the services of other suppliers to form an alliance that could then connect all of these functions together to form a virtual business model. The sub-contractor also manages all of the alliances selected by the contracting business on an operational and transactional level. This model provides a main “rail” on which another company would be able to run its business. This main “rail” is built to fully support the connectivity business functions of another company. This infrastructure is virtually built in “cyberspace,” on the Internet or other network, and is a global system, not limited to one country or location.

The terms “rail” and “virtual flow” refer to any electronic network-based communications path. The term “contracting business” refers to the entity that would be contracting services of a virtual business model, and the term “virtual business model” refers to the entity that will provide the three main flows of material/product, information, and finance.

The contracting business is responsible for developing intellectual property, branding, marketing, developing the customer base, as well as creating the strategic direction of its own overall business. The contracting business has the role of defining the business product, selecting and qualifying the raw material sources and manufacturing alliances, and ensuring that the manufacturers meet product specifications. In addition, the contracting business ensures that these sources and alliances were capable of working in the virtual environment of a virtual business model. These alliances are then “bolted” onto the virtual business model “rail” infrastructure, meaning that the rails or flows provide for electronic communication among the alliances. The virtual business model runs the operational functions for the contracting business, integrating all of the various alliances selected by the contracting business into one virtually integrated company. The virtual business model can manage all of the entire operations and flows and, from the customer's perspective, the business can appear as one integrated company.

The contracting business manages the overall business by tapping into the virtual business model infrastructure at selected points to monitor and track the world wide flow of orders, performance of the selected raw material and manufacturing alliances, and provide back to the virtual supply chain strategic information such as world wide forecasts and market shifts.

A virtual business model provides three main flows or “rails” to the contracting business: transportation of raw material and finished goods, information, and financial transactions. For the material/product flow, or “rail,” a virtual business model would handle all of the actual flow of raw material and product from one alliance to another, including warehousing where necessary, through the supply chain to the end customer. The information flow, or “rail,” of the virtual business model handles all of the order management transactions for the raw material, manufacturing and warehousing alliances to the end customer. In addition, it handles information on the movement and shipping of raw materials between alliances and final product to the end customer among all shippers such as by truck, rail, or air transport. The contracting business utilizes this information “rail” to monitor the world wide transactional data and also provide to the world wide alliances strategic direction and market direction.

The financial flow, or “rail,” handles all of the financial transactions/services between the virtual business model, the raw material alliance, the manufacturing alliance, the warehousing alliance, and the end customer. These transactions/services include, but are not limited to, credit and collections to the end customer, liability for raw material/product, as well as the accounts payable for the raw materials, manufacturing, and warehousing. The model allows for distributing liability between the contracting business and the sub-contractor, referred to as “configurable liability.” This feature allows for selectively identifying which entities will carry the financial liability, and how much liability, for the various financial flows.

These three flows are integrated into one virtual supply chain. They provide appropriate, real-time information, ensuring that the movement of materials and product, information, and financial triggers between all alliances of the supply chain occur at the most efficient and effective times. This allows a contracting business to select suppliers world wide, connect them to the virtual business model, and run their business in a virtual mode. Thus, a contracting business can conveniently integrate their products onto this “cyber-rail.” The integration can include existing systems, such as conventional financial software packages and software programs to track shipping, and it can also include custom-designed applications. The integration of existing systems with the virtual business can occur, for example, using browser-based platforms and by allowing users to interact with the virtual business through graphical user interfaces.

The virtual business model provider provides these “rails,” or flows. As indicated, these could run on their own proprietary systems, or mainstream systems. If a virtual business model did not have the capabilities of one of the main flows, such as accounts payable or accounts receivable functions, it can sub-contract that flow with another provider, for example a bank or holding company. However, the virtual business model provider would maintain the overall responsibility of entire system. The virtual business model, therefore, manages and pays the raw material sources and alliances, collects payment from the customer, then deducts all of the virtual business model costs such as transportation and logistics, as well as the service cost of running the virtual business model, and pays the contracting business the difference. In other words, the contracting business preferably only transacts financially with a provider of the virtual business.

The benefits for this virtual business model approach can include the following: real-time information throughout the entire supply chain; increased integrity and accuracy of the information and material delivery systems and processes; assurance of supply resulting in multiple suppliers more effectively connected to the supply chain, additional suppliers on-line, and strategic forecasting providing quicker response to adding capital assets and raw materials; decreased material and product cost due to real-time information and lower inventories; real-time order management; liquidity resulting in raw material and finished product (FGI) moving quickly throughout the world if required to meet regional requirements; the ability of a supply chain to adapt to suppliers skills; “plug and play” capability so that additional suppliers can be quickly added or removed to the virtual business as demand requires; a fast time to market (TTM) per employee of the contracting business; focus on the core competencies of each element of the global alliance; and allowing start-up businesses to maintain control and ownership of outsourcing by not requiring, for example, high capital expenditure or venture capital funding for the business infrastructure.

### Virtual Business Model and Method

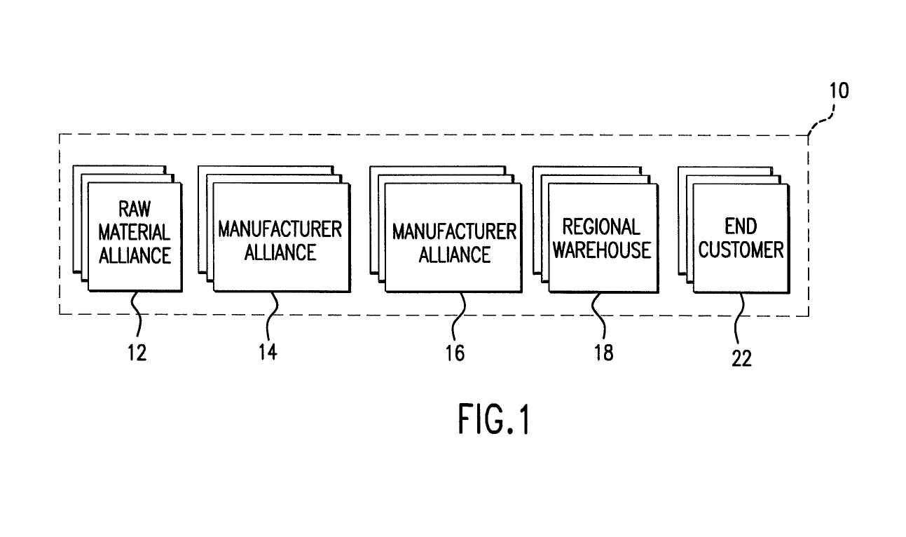

FIG. 1 is a diagram of virtual alliances and entities 10 integrated within the virtual business consistent with the present invention. Virtual alliances and entities 10 for the vertically integrated company include sources of raw materials 12, manufacturing 14 and 16, warehousing 18, and end customers 22. As illustrated, each of the alliances 12, 14, 16, and 18 can include multiple entities for each such alliance, and end customer 22 can likewise include multiple end customers. Three such multiple alliances and end customers are shown for illustrative purposes only; the business model can include more or fewer multiple alliances and end customers. The flows, as further described below, are connected with each multiple alliance and end customer.

A virtual business model provider manages the flow of materials and product throughout the entire global supply chain. This “rail” could possibly require a virtual business model to develop alliances with other logistics and distribution providers and integrate them into one comprehensive unit.

An example of this is where a virtual business model may have an expertise in moving product by air, but not by sea. The virtual business model provider can then create an alliance with a logistics provider for the movement of product by sea, which would then meet the contracting business's global need.

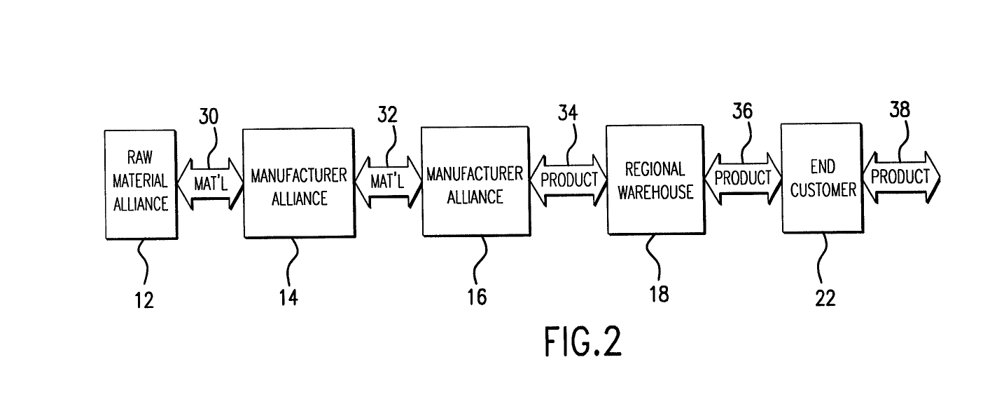

FIG. 2 is a diagram of a material and product flows within the virtual business. Raw materials are moved, as represented by paths 30 and 32, from their sources to the qualified global manufacturing alliances 12, 14, and 16 of a contracting business. Once the product or component is manufactured, it is moved onto the designated global warehousing facility, as represented by paths 34 and 36. As a customer places an order, product is moved onto the customer, as represented by path 38.

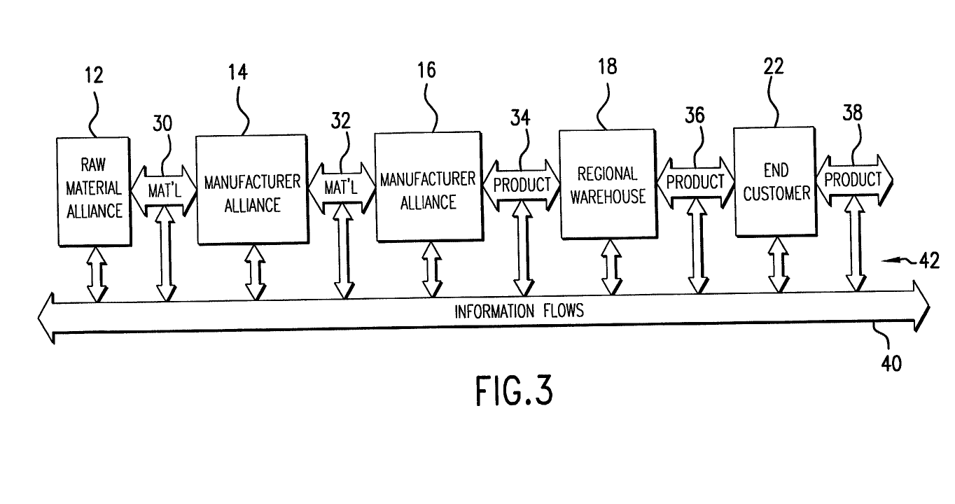

FIG. 3 is a diagram of information flows 40 within the integrated business. The information “rail” 40 integrates the movement of materials, components, and product, as illustrated by paths 40 and 42, and provide this information to both the customer buying the finished product and the contracting business. This “rail” provides the end customer visibility to only its order; however, the contracting business may have access to the entire global movement of materials and product.

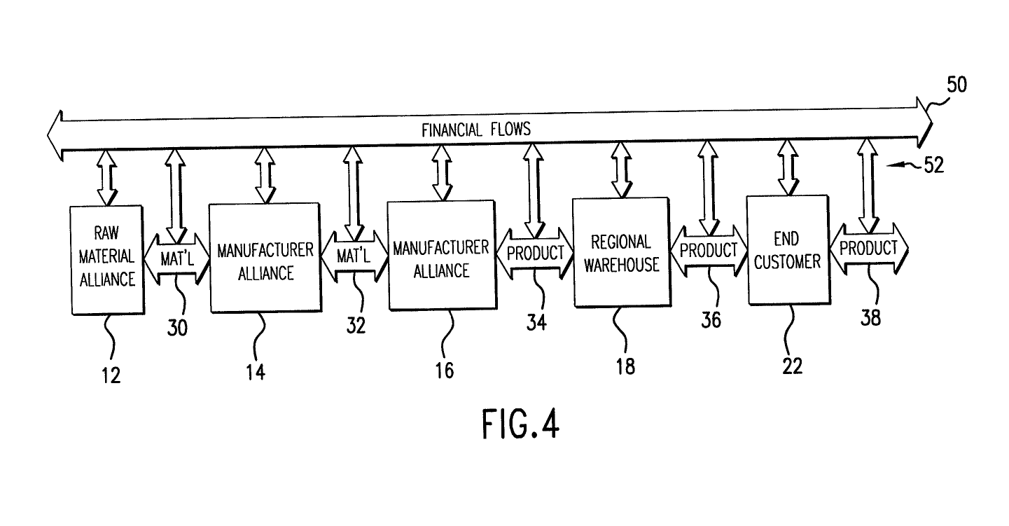

FIG. 4 is a diagram of financial flows 50 within the integrated business. As raw materials, components, and finished product move from the alliances on the global supply chain, the virtual business model has a financial “rail,” which uses data from the information “rail” 40 to trigger interdependent financial transactions throughout the entire supply chain on paths 50 and 52. For example, when raw material is moved by the virtual business model from the raw material provider, this information would be set in the information “rail,” producing a payment trigger through the financial “rail” of the virtual business model and providing immediate payment to the raw material source. This process would be the same for all of the manufacturing and warehousing alliances. When an order is shipped to an end customer, the information triggers an invoice and the credit/collections process. Thus, interdependently, payments are received from the end customer; alliances are paid, and the virtual business model determines the cost of transportation of material and product throughout the global supply chain, deducts the cost of the virtual business model services being provided, and sends the difference to the contracting business on an on-going basis.

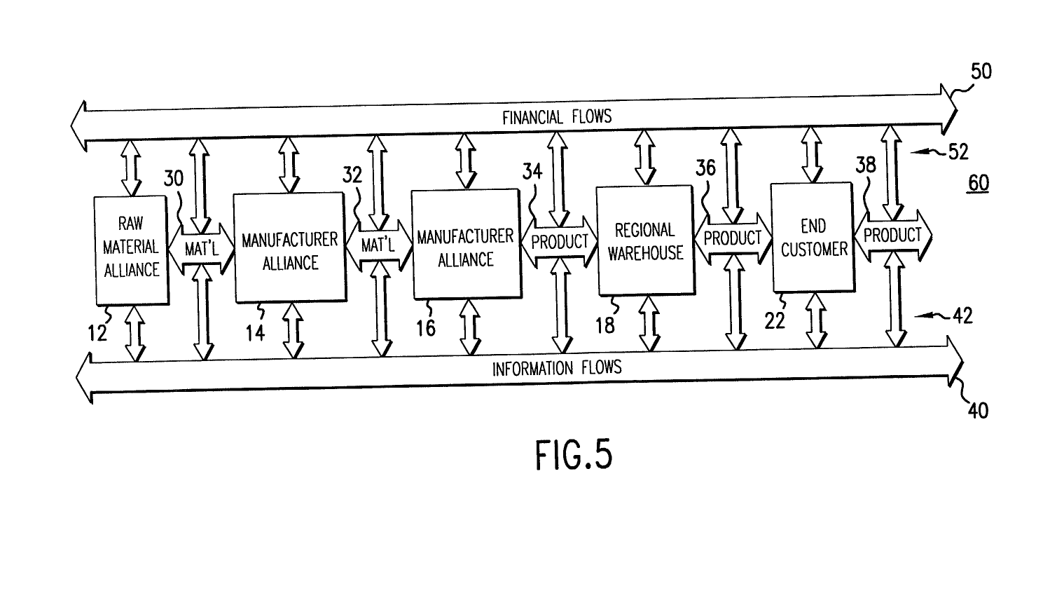

Thus, the overall virtual business model and all of its three main flows or “rails,” integrate into one system built across a global supply chain 60, as shown in FIG. 5. FIG. 5 represents a fully integrated virtual enterprise system, built upon the infrastructure of sub-contracted service provider, linking global alliances, and leveraging the core competencies of each. The infrastructure for the linking can include, for example, the world wide web and standard Internet communications protocols.

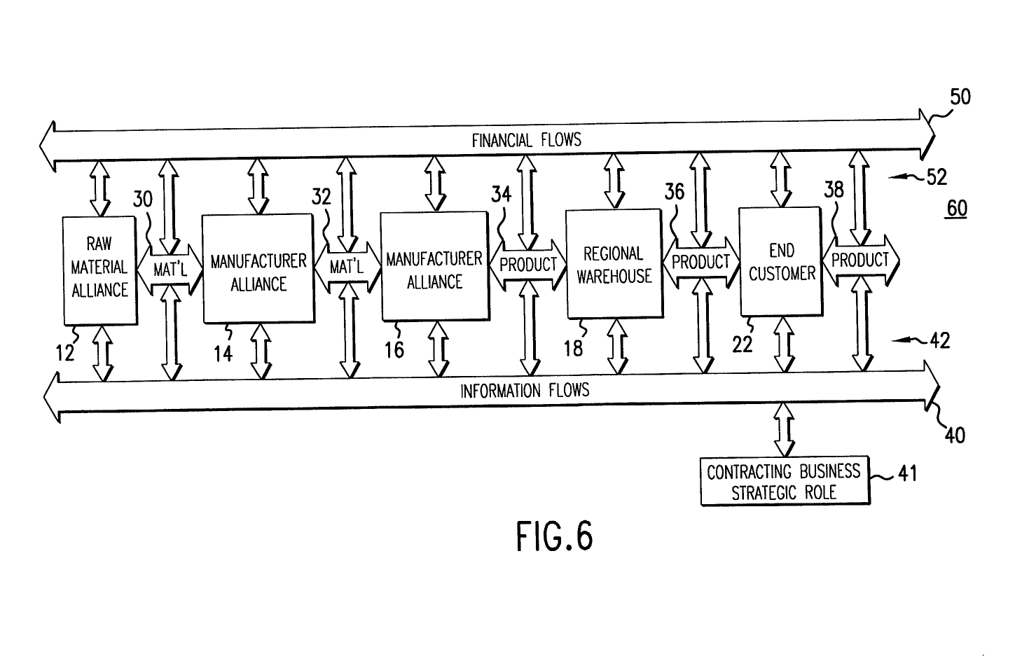

FIG. 6 is a diagram illustrating interaction between a contracting business strategic role 41 and the information flows 40 and 42 within the integrated business. A final piece of the virtual business model system is its ability to provide the contracting business with access to all of the information within the system. This allows the contracting business to manage a sub-contracted global enterprise with limited resources of its own. In addition, it allows each component to focus on its own core competencies. In addition, it allows all of the alliances connected to the model to integrate more efficiently for better overall effective management of the entire supply chain. The efforts of the contracting business focus on monitoring the various order, material, and product flows; track and monitor the performance of their selected and qualified material and manufacturing alliances; utilize the information to make strategic and informed decisions as to the direction of the business; and provide back through the global supply chain strategic and market direction. This integration allows all the alliances to make better, informed decisions on procuring, or reducing additional capital assets, resources, and materials. The virtual business model provider can focus on the movement of material and product, and financial flows.

### Example of Using the Virtual Business Model and Method

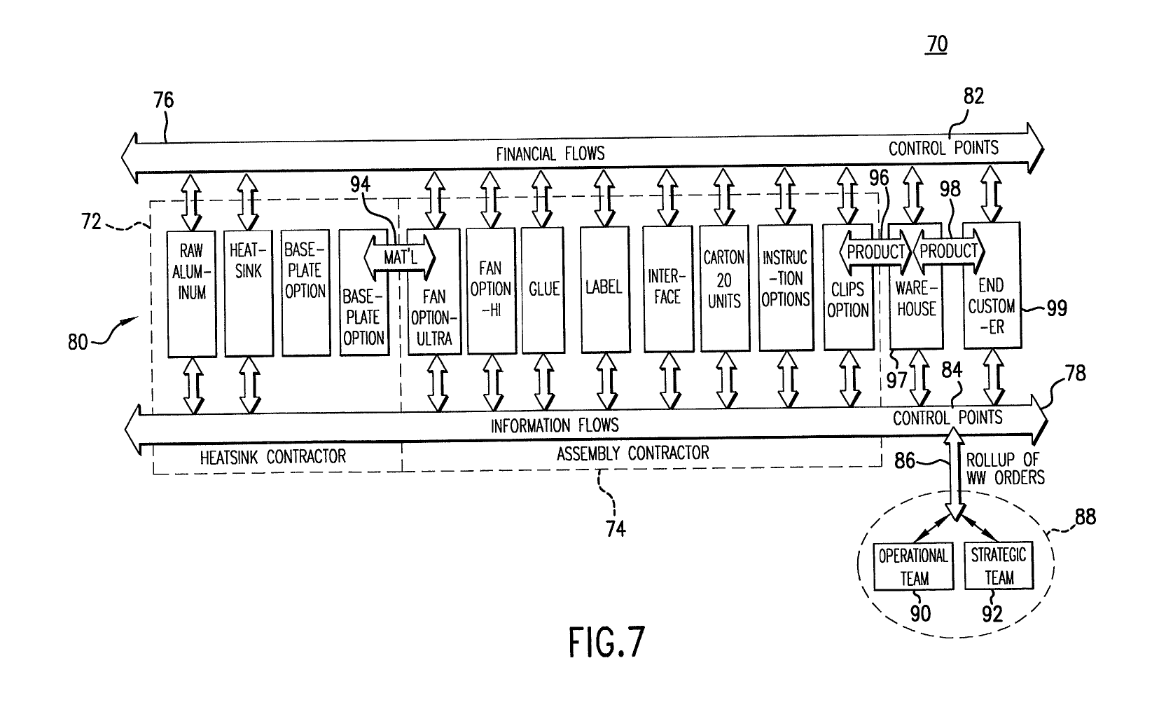

The virtual business model allows the contracting business to set up a global supply chain on a network-based platform to best meet its business needs. For example, FIG. 7 shows a global supply chain 70 for a heatsink product.

This is a simplified version of the virtual business model, since, in this example, the virtual business model only manages the movement of FGI from the assembly alliance to the warehousing facility, and then to the end customer. The virtual business model 70 can manage the entire supply chain if the contracting business required it. In this example, the assembly manufacturer 74 is the “control point” '84 for this business. This means that the assembly alliance manages all of the providers of raw materials among units 80. The second “control points” 82 in the system are the order points with the customer. These control points are configurable by a contracting business, meaning that contracting businesses have the flexibility to configure control points to meet their business requirements.

This configuration is how the contracting business decided to set-up and manage its global operations for this example. It is also possible for the contracting business to set up the alliances such that the entire supply chain were managed by the virtual business model. This would have required, though, more cost from the virtual business model provider, as well as more developed alliances in the global supply chain in this example. These are the types of considerations that the contracting business and the virtual business model provider can take into consideration when the alliances are set up initially.

Thus, in this example, the customer places an order on the virtual business model 70, as though it were the contracting business. The order is then transferred through the virtual business model information “rail” 78 to the selected manufacturing alliance such as the heatsink contractor 74, who acknowledges the order, provides status of the product, and then ships to the warehouse alliance via the virtual business model transportation infrastructure according to the committed date. Once the order has been shipped, the virtual business model 70 initiates an invoice to the end customer, as well as initiates payment to the assembly alliance for the product shipped. The information rail 78 can be used to control the flow of material, as illustrated by path 94, and the transport of the final product to a warehouse 97 as represented by path 96 and to the end customer 99 as represented by path 98.

This invoice and payment information is called transactional information since the various alliances use it to transact business using financial rail 76. This transactional information is monitored by the contracting business, in this case the operational team 90 and strategic team 92. These teams interact with the information rail 78 via a communications path 86 for the roll-up of world wide orders. This monitored transactional information is used to monitor the order rates in each region, as well as the performance of each manufacturing and raw material alliance that has been set up for this business.

The operational and strategic teams 90 and 92 use this data to determine potential upside and downside inflection points. This information can then be integrated with any marketing or strategic forecasts, as well as strategic customer movements, to create an overall understanding of where the business is headed. This world wide forecast and prediction of business demand is fed back into the information “rail” 78 of the virtual business model to all of the various alliances, including raw material/components, manufacturing, and warehousing, in order for these alliances to adjust their business plans to either increase asset utilization in times of upside or decrement the procurement and utilization of assets in times of downward demand. The virtual business model can thus ensure that all alliances, including the virtual business model, have accurate and timely information in order to fully run the virtual business, as if it were a truly vertically integrated business having all of the same controls, operations, and resources as a complete vertically integrated business.

These operational and strategic teams 90 and 92 are also responsible for the long-term performance of the selected suppliers. Since the virtual business model is managing the day-to-day alliances, the teams oversee the long-term performance. If a selected alliance is under-performing, it is the role of the teams to intervene and either escalate to improve performance or move to another alliance.

In addition, the teams 90 and 92 serve as a world wide allocation focus unit. If there were to be issues of raw materials or product in one region of the world, the teams are responsible for coordinating the cross-regional movement of material or product until the situation is resolved. Once the situation is resolved, the role of managing the alliances returns to the virtual business model.

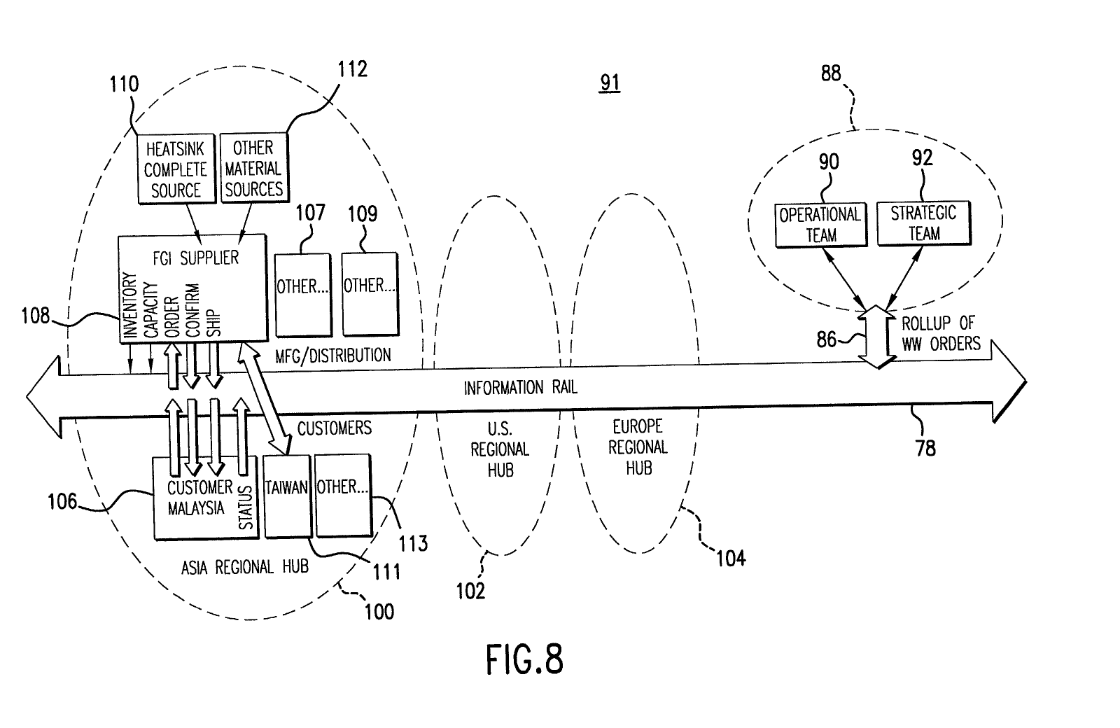

FIG. 8 is diagram of a model 91 illustrating another example of how the virtual business is viewed from a world wide perspective and provides another view of the model illustrated in FIG. 7. The virtual business model provides the “rail” infrastructure of the three main flows: material/product (94, 96, 98), information (78), and finance (76). Model 91 illustrates interaction on the information rail 78 with virtual geographic hubs, examples of which include an Asia regional hub 100, a United States regional hub 102, and a Europe regional hub 104. Each virtual geographic hub can include its own virtual suppliers and customers. For example, the Asia regional hub 100 includes an FGI supplier 108 and possibly other suppliers 107 and 109 on the information rail 78. In the virtual model, FGI supplier 108 can use material sources 110 and 112 for coordinating the manufacture of a heatsink in this example.

Customers in the Asia regional hub can be divided geographically as well in the virtual model. This example illustrates customers in Malaysia 106, Taiwan 111, and possibly other countries 113 in Asia. The customers in the virtual model can interact via the information rail 78 in order to obtain, for example, status information concerning their orders.

The contracting business 88 monitors orders throughout the world. The end customer in each region places the order through the virtual business model infrastructures; the assembly alliance acknowledges and ships product. The virtual business model manages financial transactions once a product is shipped. The virtual business model also manages the relationship of the FGI, or assembly alliance. The contracting business manages the overall business, in this example.

While the present invention has been described in connection with an exemplary embodiment, it will be understood that many modifications will be readily apparent to those skilled in the art, and this application is intended to cover any adaptations or variations thereof. For example, various types of networks, communications paths and protocols, and software packages and machines connected to the paths, may be used without departing from the scope of the invention. This invention should be limited only by the claims and equivalents thereof.

1. A method of using a virtual business model to transact business for a product, comprising:
providing a plurality of virtual alliances for the manufacture and distribution of the product;
providing a plurality of virtual flows for enabling electronic communication between the plurality of virtual alliances for use in the manufacture and distribution of the product;
providing a contracting business for coordination among the virtual alliances; and
using the contracting business to establish, via the virtual flows, control over the manufacture and distribution of the product by the plurality of virtual alliances.

2. The method of claim 1 wherein the providing the plurality of virtual alliances includes providing a material alliance.

3. The method of claim 1 wherein the providing the plurality of virtual alliances includes providing a manufacturer alliance.

4. The method of claim 1 wherein the providing the plurality of virtual alliances includes providing a warehouse alliance.

5. The method of claim 1 wherein the providing the plurality of virtual flows includes providing a material and product flow.

6. The method of claim 1 wherein the providing the plurality of virtual flows includes providing an information flow.

7. The method of claim 1 wherein the providing the plurality of virtual flows includes providing a financial flow.

8. The method of claim 1 wherein the using the contracting business includes establishing configurable control points in the information flow for facilitating communications by the contracting business.

9. The method of claim 6, further including establishing virtual regional hubs on the information flow for coordinating the manufacture and distribution of the product for customers in particular geographic locations.

10. The method of claim 1 wherein the providing the plurality of virtual flows includes providing financial and information flows, and further including using the financial flow integrated with the information flow to automatically trigger financial transactions relating to the manufacture and distribution of the product.

11. A virtual business model to transact business for a product, comprising:
a plurality of virtual alliances for the manufacture and distribution of the product;
a plurality of virtual flows for enabling electronic communication between the plurality of virtual alliances for use in the manufacture and distribution of the product; and
a contracting business for coordination among the virtual alliances, wherein the contracting business establishes, via the virtual flows, control over the manufacture and distribution of the product by the plurality of virtual alliances.

12. The virtual business model of claim 11 wherein the plurality of virtual alliances includes a material alliance.

13. The virtual business model of claim 11 wherein the plurality of virtual alliances includes a manufacturer alliance.

14. The virtual business model of claim 11 wherein the plurality of virtual alliances includes a warehouse alliance.

15. The virtual business model of claim 11 wherein the plurality of virtual flows includes a material and product flow.

16. The virtual business model of claim 11 wherein the plurality of virtual flows includes an information flow.

17. The virtual business model of claim 11 wherein the plurality of virtual flows includes a financial flow.

18. The virtual business model of claim 11, further including configurable control points in the information flow for facilitating communications by the contracting business.

19. The virtual business model of claim 16, further including virtual regional hubs on the information flow for coordinating the manufacture and distribution of the product for customers in particular geographic locations.

20. The virtual business model of claim 11 wherein the plurality of virtual flows includes financial and information flows, and further including financial transactions automatically triggered by the financial flow, integrated with the information flow, and relating to the manufacture and distribution of the product.
